(19) United States
(12) Patent Application Publication
(10) Pub. No.: US 2008/0134084 A1
(43) Pub. Date: Jun. 5, 2008

(54) Domain Bar

(75) Inventors: Renee Clark, Fairfax, VA (US); David W. Morse, Fairfax, VA (US); Peter Feinberg, McLean, VA (US); Jeff Grosman, Washington, DC (US); Gary Khachadoorian, Clayton, CA (US); Michael A. Wooldridge, Pleasant Hill, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Network Solutions, LLC, Herndon, VA (US)

(21) Appl. No.: 11/933,001

(22) Filed: Oct. 31, 2007

Related U.S. Application Data
(63) Continuation of application No. 11/410,279, filed on Apr. 25, 2006.
Application No. 11/410,279 is a continuation-in-part of application No. 11/224,083, filed on Sep. 13, 2005, now abandoned.
(60) Provisional application No. 60/674,315, filed on Apr. 25, 2005.
(60) Provisional application No. 60/609,003, filed on Sep. 13, 2004.
(60) Provisional application No. 60/622,841, filed on Oct. 29, 2004.

(51) Int. Cl. G06F 17/30; G06F 3/048; G06F 15/16

(52) U.S. Cl. 715/808; 707/3; 709/206; 707/E17.014

(57) ABSTRACT

A toolbar for WHOIS searching and interacting with a domain name registrar. The toolbar may include buttons, form fields and drop down menus, and performs WHOIS searches, WHOIS wildcard searches, provides domain registration services. Queries include WHOIS domain searches by domain, by IP address, and by Network Information Center (NIC) Handle searches. Domain registrations can be created, transferred and renewed.

### RELATED APPLICATIONS

This application is a continuation-in-part of prior application Ser. No. 11/224,083 filed Sep. 13, 2005, which claims the benefit of U.S. Provisional Application Nos. 60/609,003 filed Sep. 13, 2004 and 60/622,841 filed Oct. 29, 2004. This application also claims the benefit of U.S. Provisional Application No. 60/674,315 filed Apr. 25, 2005. Application Nos. 60/609,003, 60/622,841, 60/674,315, and Ser. No. 11/224,083 are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

WHOIS is a protocol for submitting a query to a database for determining, among other things, the owner of a domain name, an Internet Protocol (IP) network, or an autonomous system number. Several public websites in the market let users do domain name searches or WHOIS searches. However, in order to use these services, a user must navigate to the website. For users who regularly perform such searches, working in areas such as network management, web hosting and design, and trademark practice, the additional navigation and windows needed to initiate a search are obtrusive.

Accordingly, there is a need for an unobtrusive search utility that is always available when a web browser is open.

### SUMMARY OF THE INVENTION

A toolbar is disclosed for WHOIS searching and interaction with domain name registrars. The bar may include buttons, form fields and drop down menus, such as an entry field with a search history drop down, a new domain search button (action), a WHOIS search button (action), a wildcard search button (action), an options button or menu (configuration menu), an alerts button or menu (action), and additional access to additional features such as a pop-up blocker enable/disable button (report and action) and a help drop down menu.

Queries include WHOIS domain searches by domain, by IP address, or by Network Information Center (NIC) Handle and WHOIS wildcard searches. Provision is also made to send alerts to the toolbar.

### BRIEF DESCRIPTION OF THE DRAWINGS

FIG. 1 is a flow chart illustrating operation of a toolbar according to first and second embodiments of the invention.

FIG. 2 is a block diagram illustrating operation of a toolbar according to the first and second embodiments of the invention.

FIG. 3 is a first exemplary result of a WHOIS search.

FIG. 4 is a flow chart illustrating how the subject matter of the WHOIS search can be recognized.

FIG. 5 is a second exemplary result of a wildcard WHOIS search.

FIG. 6 is an example of a toolbar in accordance with the first and second embodiments.

FIG. 7 illustrates a variation on the pull-down/drop down menu shown with the toolbar in FIG. 6.

FIG. 8 illustrates a pull-down/drop down menu for designating a default search type.

FIG. 9 is a flow chart illustrating a search operation in conjunction with a pop-up menu.

FIG. 10 is an exemplary pop-up menu used with the operation of FIG. 9.

FIG. 11 is an exemplary result of a domain name search.

FIG. 12 is an exemplary options dialogue box for customizing behavior of the toolbar.

FIG. 13 illustrates a search history feature.

FIG. 14 is an exemplary display of an alert by the toolbar.

FIG. 15 illustrates a pop-up blocker feature of the toolbar.

FIG. 16 illustrates a browser-and-system tools interface of the toolbar.

FIG. 17 illustrates a text stream “ticker” integrated into the toolbar.

FIG. 18 illustrates components of an exemplary computer system upon which the toolbar may reside.

### DETAILED DESCRIPTION

A first embodiment of the invention is a toolbar plug-in to a browser program providing access to WHOIS searching. A second embodiment of the invention is a toolbar plug-in to a browser program providing access to a domain name registrar.

These embodiments may be implemented with additional searching functionality, and may be used in combination.

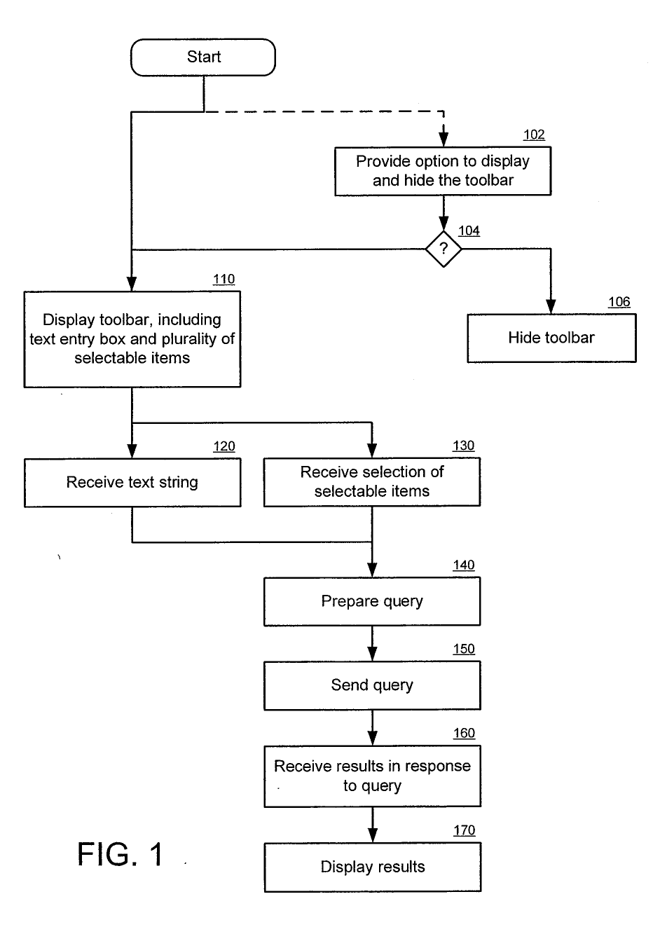

FIG. 1 is a flowchart illustrating operation of the toolbar in accordance with the first and second embodiments of the invention.

The toolbar may provide an option to display or hide the toolbar (102). If an instruction is received to hide the toolbar (104), the toolbar bar is hidden (106). Otherwise, the toolbar is displayed (110) in the browser window. If the toolbar is displayed, at least a portion of the toolbar is persistently displayed, independent of changes in content displayed by the web browser program.

The toolbar includes a text entry box and a plurality selectable items. The text entry box is a receptacle for the information to be searched. The plurality of selectable items define, among other things, types of searches which can be performed and particular interactions with a domain name registrar. Exemplary selectable items may be in the form of buttons, a pull-down menu, or some combination thereof.

After a text string is received in the text box (120), and a selection is received of a selectable item (130), an agent prepares (140) a search query based upon the text string and the selected selectable item. In a client-server model, an agent is the part of the system that performs information preparation and exchange on behalf of a client or server.

The query is then sent over a network (150), a response to the query is received (160), and the response is displayed (170) on the computer having the toolbar.

In the first embodiment, the selectable items comprise searches for a WHOIS database, and the query sent (150) is for a WHOIS database. In the second embodiment, the selectable items comprise interactions with a domain name registrar, and the query sent (150) is for a domain name registrar. In both embodiments, the query may be sent either directly to its destination, or may be sent to a proxy or intervening service. Also, while the agent is preferably embedded within the toolbar plug-in application program, the agent may reside elsewhere, such as with the proxy or intervening service. In any case, the query sent by the toolbar is based upon the received text string and the selected item.

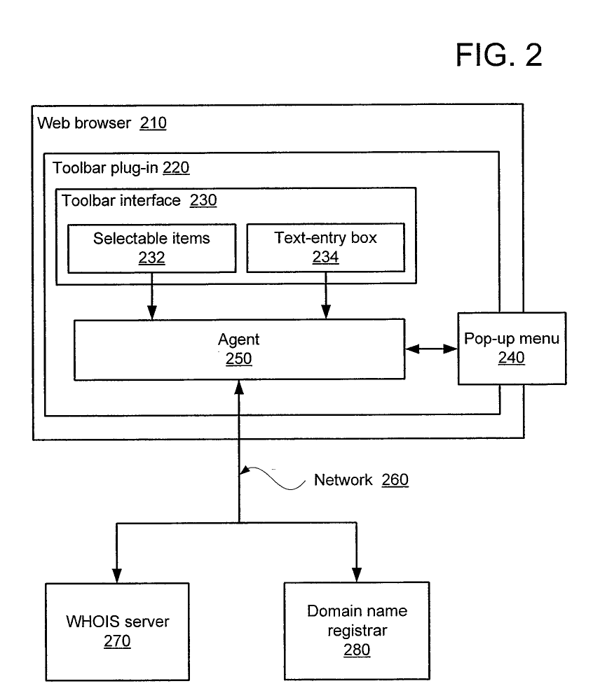

FIG. 2 is an exemplary block diagram illustrating operation of the toolbar according to the first and second embodiments of the invention. The toolbar (220) is a plug-in to a web browser (210), and includes a toolbar interface (230) and the agent (250). The toolbar interface (230) displays the selectable items (232) and the text-entry box (234). The agent (250) send the queries for the WHOIS server (270) and the domain name registrar (280) over a network (260), and the results of the queries are displayed. The agent may also receive a selection of selectable items from a pop-up menu (240) as an additional feature discussed below.

As an exemplary operation, if the user enters a variable in the entry field (234), and clicks a selectable item for “Domain Search”, the toolbar will execute a new domain search of the specified value. The user may specify the top-level domain (TLD) to be searched in the entry field (234), for example, “nsi.com”. If the user does not specify a TLD, the toolbar may append on a TLD such as “.com” before executing the search command, or treat the search as a wildcard search.

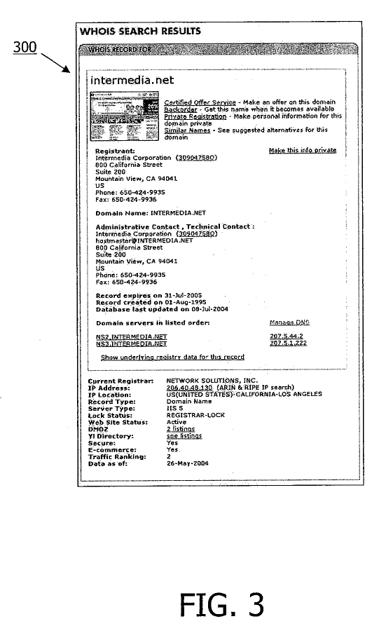

FIG. 3 is an example of WHOIS search results (300) which may be received and output in response to the query of the first embodiment. The search results (300) may be displayed through the web browser program (210), in an existing window or in a new tab or window.

In accordance with the first embodiment, the types of searches and selectable items displayed may include a domain name WHOIS search, an IP address WHOIS search, a WHOIS search based upon a Network Information Center (NIC) handle, and a wildcard search.

The wildcard search may be a WHOIS search of at least all current domains, and may further include deleted domains. The wildcard search may be a literal wildcard search and may look for all active, deleted and formerly registered domains that contain that literal phrase (either preceded by other characters, and/or before other characters).

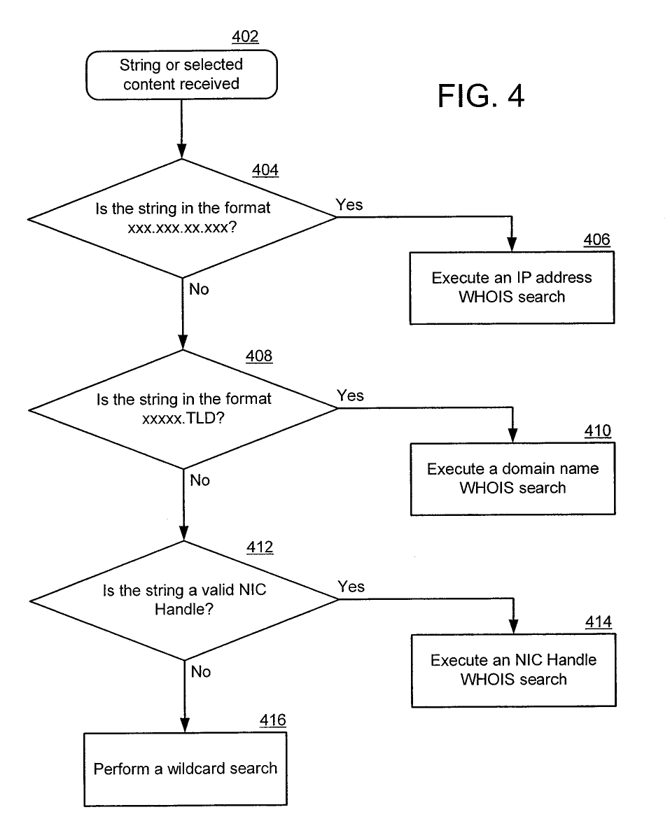

Additionally, the different search types may be a static list of options, presented without regard to the search string received, or may be dynamically adjusted based on the search string. As shown in FIG. 4, when a search string (402) is received, it may be parsed to determine the appropriate search. For example, if the string is in an IP address format (404), an IP address WHOIS search is executed (406); if the string is in the format of a domain name (408), a domain name WHOIS search is executed (410); if the string appears to be a valid NIC handle (412), a NIC handle WHOIS search is executed (414); and if none of the other formats apply, a WHOIS wildcard search may be performed (416). Accordingly, if a menu is used to present the selectable items, the items enabled in the menu may be defined as those types of searches that are possible for the entered string. Likewise, refutation can be used to eliminate or deselect items in the menu that do not correspond to the format of the entered string.

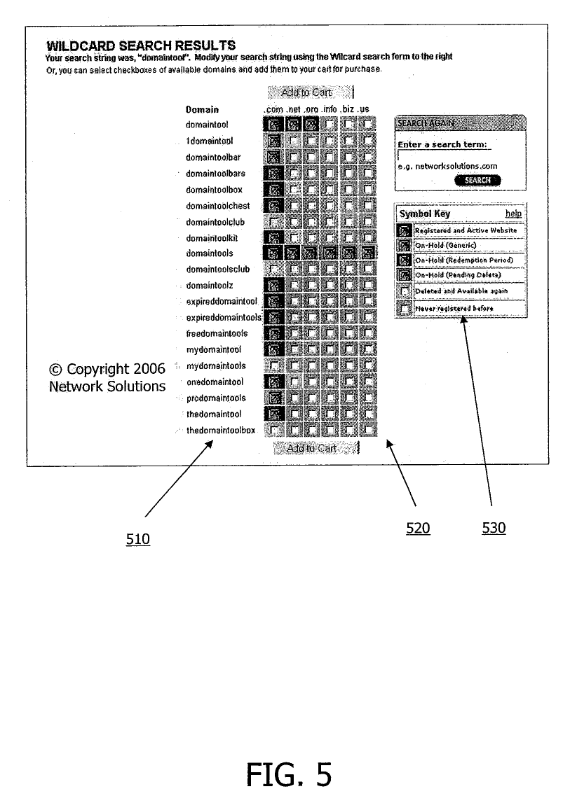

FIG. 5 illustrates exemplary results of a WHOIS wildcard search in which an independent status (520) is provided for each domain (510). For example, a search may be run against a plurality of extensions (e.g., com, net, org, biz, info, tv, us, cc, ws, bz, vg, gs, tc, ms) which are displayed in the results with an indication as to whether each are available.

A symbol key (530) identifies different types of status available, such as “registered and active website,” “on-hold (generic),” “on-hold (redemption period),” “on-hold (pending deletion),” “deleted and available again,” and “never registered before.” When “registered and active,” “On-Hold (Generic),” “On-Hold (Redemption Period),” or “On-Hold (Pending Delete)” is selected (i.e., clicked), a WHOIS search argument may be sent (e.g., 150), as described above, and a WHOIS Search Results Page is received and displayed (e.g., 160, 170). Any available domain may be represented with a checkbox that, if checked when the “Add to Cart” button is clicked, will send a multi-argument string to a domain name registrar as a new domain search query.

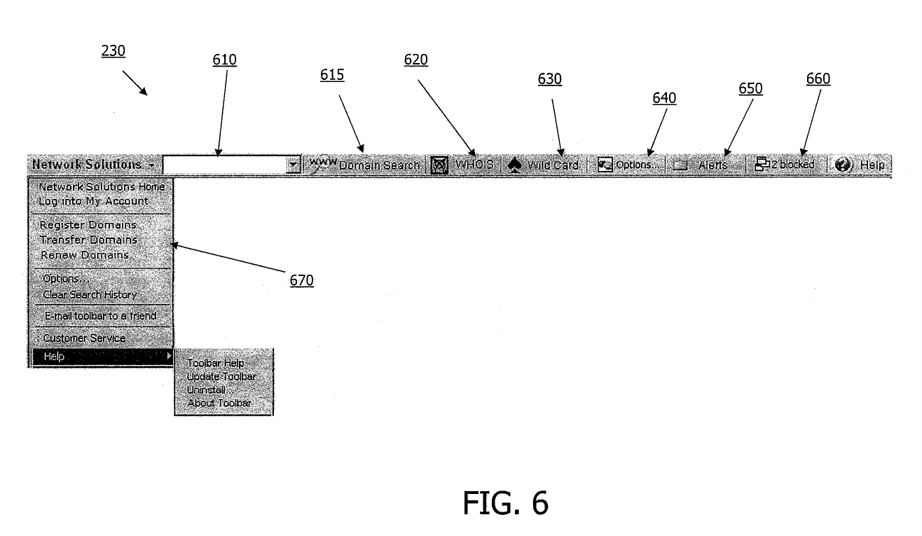

FIG. 6 is an example of a toolbar in accordance with the first and second embodiments of the invention. Text is input via the text entry box (610). Selectable items are illustrated as both pull-down/drop-down menus (615, 670) and buttons (620, 630).

As an example that may be used with any of the embodiments, a pull down/drop down menu (615) includes a list of search types and functions available via the toolbar (220), with the selected choice from the list becoming the default displayed by the header in the toolbar (the initial default being “Domain Search”, as shown in FIG. 6). As an alternative to automatically parsing the text string, as discussed above with FIG. 4, the default search-type or function selected in the menu (615) may designate what type of search is performed when text is entered in the text entry box (610). With the combination of the text box (610) and the default search type (615), a search may be performed directly from the tool bar without further navigation or menus.

As an example that may be used with the second embodiment, the pull-down/drop-down menu (670) includes a list of interactions with a domain name registrar. The buttons (620, 630), initiate a WHOIS search, as might be used with the first embodiment. Either form of selectable items (menus, buttons) may be used with either embodiment. In addition, the toolbar illustrated in FIG. 6 includes examples of other features which may be included, such as a selection for user-configurable options (640), a link to, or menu of, alerts (650) that may be received through the toolbar, and a pop-up blocker feature (660) (e.g., blocking unwanted pop-up advertisements and the like) that reports the number of windows blocked.

Examples of features that may be included in the drop-down menu (670), as illustrated in FIG. 6, include a link to the toolbar provider's homepage (e.g., a registration service provider); a link to log in to an affiliated account; options to register, transfer, and renew domains; access to toolbar options (e.g., a duplicate pathway to menu 640); the ability to clear a search history; an option to e-mail the toolbar to a friend; a link to toolbar customer service; and a link to help or a help sub-menu drop down. The menu selection for “E-mail Toolbar to a Friend” may invoke a user's default client e-mail application (e.g., Microsoft® Outlook®) with a pre-formatted HTML message included with the toolbar by the toolbar provider. The menu selection for “Customer Service” may invoke a Uniform Resource Locator (URL).

A help sub-menu may include a variety of options. A first sub-menu option may be “Toolbar Help,” which will take the user to a general toolbar help website at a specific URL. A second sub-menu option may be “Update Toolbar,” which will pull new code from a remote distribution application. The toolbar may communicate with the distribution application to identify it's unique “AffiliateID” (i.e., a unique identifier assigned to the toolbar), then compare the current toolbar version to the latest version. If the user has an out-of-date version, the distribution application may re-load the AffiliateID into a new toolbar and send the customer an executable with the new toolbar version inside. If the user has the current version, the distribution application may serve a dialogue box that says, “You have the most recent version of the toolbar already”.

A third sub-menu option may be “Uninstall . . . ”, which will serve the user a dialogue box such as, “If you click UNINSTALL below, this toolbar will be completely removed from your machine” with the option to “CANCEL” or “CONTINUE”. If the user clicks “UNINSTALL”, the application can remove all toolbar code and objects completely from the user's desktop machine without a trace. A fourth sub-menu option may be “About Toolbar”, which serves a page that tells the user basic “about” information.

Other “help” sub-menu offerings may include “Frequently Asked Questions” and access to a message gateway for providing feedback about the toolbar.

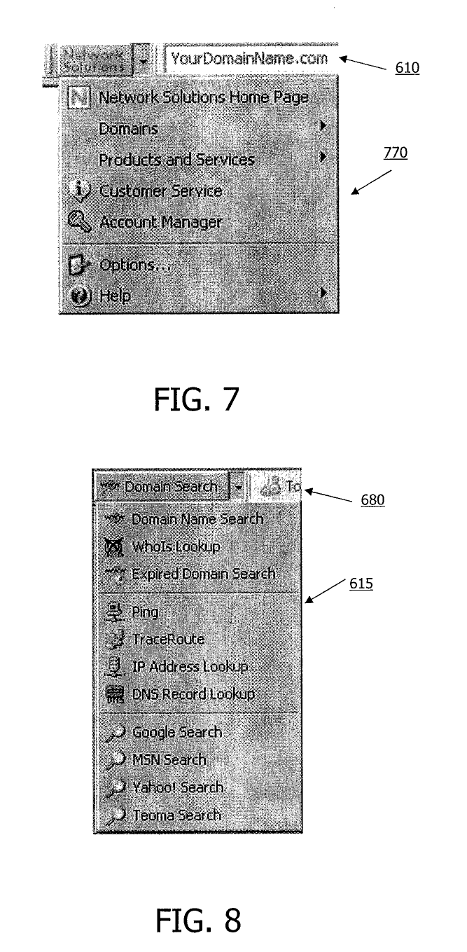

FIG. 7 is another example of a pull-down/drop-down menu 770, as a variation on menu 660. As in menu 660, menu 770 provides a link to the toolbar provider's homepage, a link to a customer service website, access to toolbar options, and access to help or a help sub-menu drop down. Similarly, the “Account Manager” link in menu 770 is a relabeling of the “Log into My Account” in menu 660.

In menu 770, in comparison to menu 660, the options to register, transfer, and renew domains have been folded into a “Domains” sub-menu to lessen clutter. The “Domains” submenu may also incorporate related functionality, such as offering a user the option to search for and then place an order or backorder on an expired domain.

Another feature added to menu 770, in comparison to menu 660, is the “Products and Services” submenu. This submenu provides links to purchase hosting, web sites, and e-mail.

FIG. 8 illustrates an example of the pull down/drop down menu (615) that includes a list of default search types and functions, as described above. Examples of searches and functions that may be selected as the default action for text entered in the text box (610) include a domain name search; a WHOIS lookup; an expired domain name search; a network Ping; execution of a TraceRoute (also known as Tracert); an IP address lookup; a DNS record lookup; or a search via various search engines. The agent (250) routes each request to the appropriate service, which may be at different locations than the WHOIS (270) and domain name registrar (280) services.

Ping is a service that sends out an echo request to a specific site on the internet. It can be used to check communication links or check whether the specific host is running. The host can be designated by either domain name or IP address to conduct the Ping.

TraceRoute determines the path a packet is taking across the Internet. It looks up each machine along the path to a destination host and displays the corresponding name and IP address for that hop. With each name is the number of milliseconds to get to the destination. The destination host can be designated by either a domain name or an IP address to conduct the TraceRoute.

An IP address lookup resolves a website address (URL) to an IP address, whereas a DNS Record Lookup contacts a Domain Name Server to determine the resource records for the specified domain.

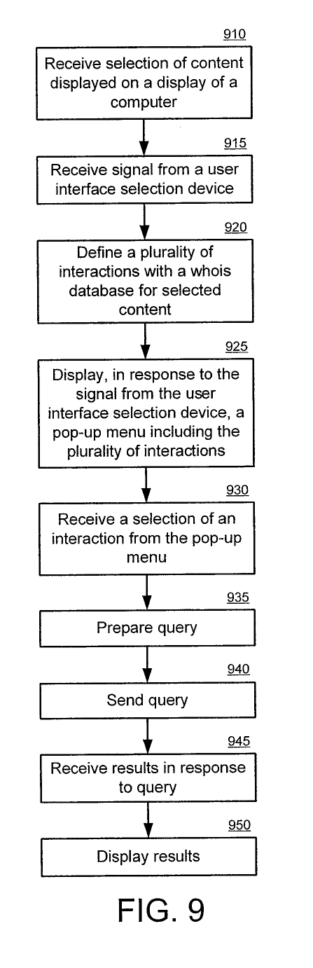

As an additional feature of the first embodiment, searches may be initiated using text or an object displayed by the computer and selected by a user. As shown in FIG. 9, a selection of content displayed on the computer is received (910). This content may include, among other things, text or a graphic object including embedded information. After a signal is received (915) from a user interface selection device (e.g., mouse or other pointing device, or keyboard), a plurality of interactions with a WHOIS database are defined for the selected content (920). This plurality of interactions may be a static list, may be pre-designated by the default action (e.g., designated by menu 615), or may be tailored to content of the selected text or object, as discussed above with regard to FIG. 4. The signal may be, for example, a “click” from a particular mouse key or a predetermined keystroke.

Thereafter, the plurality of interactions is displayed in an interactive pop-up menu (925). After a selection is received from the pop-up menu (930), using the same techniques as discussed above, a WHOIS query is prepared (935) and sent (940), and after a response is received (945), the results are displayed (950).

In addition to WHOIS searches using a WHOIS database (270), the process illustrated in FIG. 9 may be used with other types of operations, such as DNS record lookups and searches passed to a search engine. Such other types of operations are included in the interactions defined in step 920 and the destination of the query (940) is modified according to the type of operation performed.

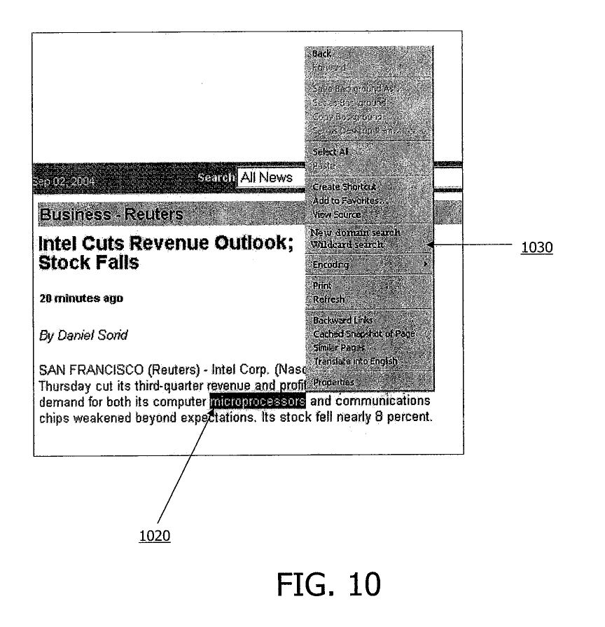

FIG. 10 illustrates an example of how the interface to the features of FIG. 9 might appear. In particular, FIG. 10 shows a selection of text (1020) and a pop-up menu (1030) containing a plurality of selectable items corresponding to predefined interactions with a WHOIS database. In this example, the user has highlighted the word “microprocessors” (1020) in the page body, and clicked the right-hand mouse button to get the displayed menu (1030).

In the pop-up menu (1030), the toolbar has populated additional options underneath the “View Source” entry, (1) “New domain search” and (2) “Wildcard search,” that will act just as though the user clicked either the “Domain Search” or the “Wildcard Search” button, respectively. “New domain search” may initiate a search in accordance with the techniques discussed above with regard to FIG. 4.

The selected text or object may appear in the web-browser or in an address bar of the web browser. However, depending upon the support offered by the operating system of the computer, it is also possible to receive selected text and objects from other applications. Additionally, the pop-up menu (1030) WHOIS search feature of the toolbar plug-in may be utilized, even when the toolbar itself is hidden. Further, although the above implementation of the pop-up menu WHOIS search is as a part of the toolbar, another embodiment of the invention is to implement the pop-up menu WHOIS search as a stand-alone application or plug-in, retaining the agent (250) but omitting the toolbar interface (230).

Other functions may also be integrated into the offerings of the pop-up menu (1030), such as performing an IP address lookup, a DNS record lookup, a general search, or other functionality as described in connection with the menus (615, 670, 770) above.

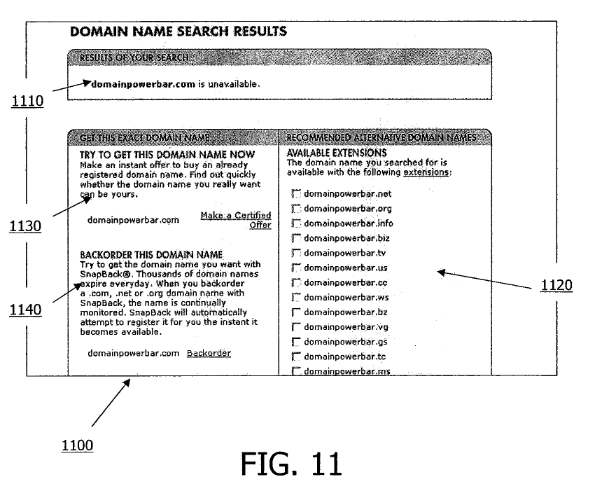

FIG. 11 is an exemplary result (1100) displayed in response to a request to a domain name registrar in accordance with the second embodiment. In this example, a domain registration was attempted from the toolbar, but the domain name is unavailable (1110). This response includes a list of alternative domains that might be registered (1120), an option to use a broker service to buy the domain from the existing owner (1130), and the option of placing a backorder on the domain name, should it become available (1140). The search results (1100) may be displayed through the web browser program (210).

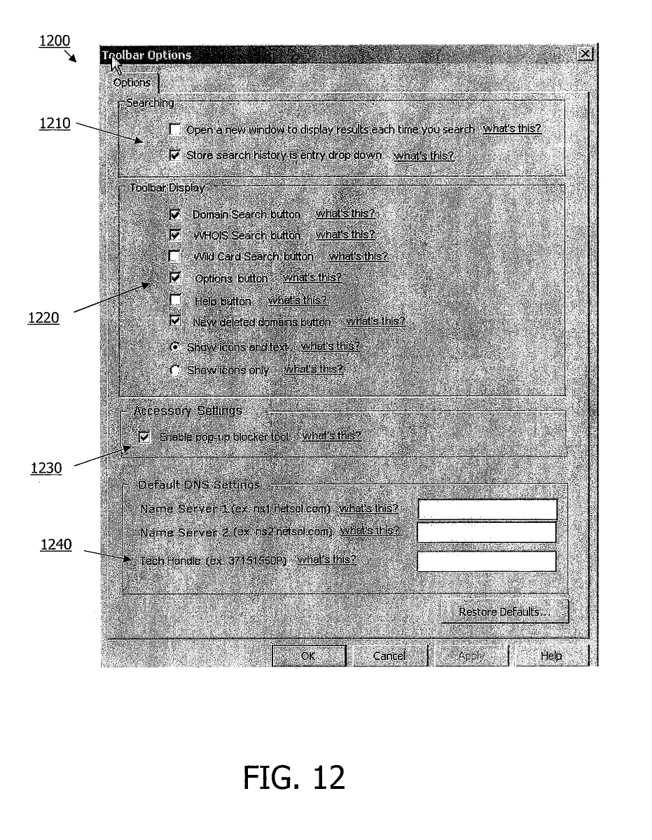

FIG. 12 is an exemplary options dialogue box (1200) accessed via the “options” button (640) of the toolbar or “options” in the pull down/drop down menus (670, 770). Examples of options that may be provided include customizing search and toolbar behavior (1210), customizing what features appear on the toolbar (1220), what accessories are enabled (1230), and any network-specific information (1240) which may be provided to the toolbar. As illustrated, the search and toolbar behavior (1210) include select-box options to open a new window to display results each time a search is executed, or if the search results will come up in the current browser window; and whether to store a search history and display the history in an entry box drop down. Customization (1220) includes selecting which buttons will appear on the toolbar, and whether the toolbar buttons are icons or icons and text. If a user disables the “options” button (640) in the toolbar interface (230), the options dialogue box (1200) can still be accessed via the pull-down/drop-down menu (670, 770). If a user de-selects all of the buttons which may be displayed in the toolbar, but the user enters a search string in the text entry field (e.g., 610) and clicks ENTER, the toolbar will perform a default search, which can be set to be a new domain search. Moreover, even if the buttons are off, “WHOIS search,” “wildcard search,” and the like may still appear in the drop-down menu (e.g., 615, 670, 770, 1030).

An exemplary accessory which can be enabled or disabled (1230) is a pop-up window blocker. The toolbar may keep a tally of the number of pop-ups blocked (e.g., field 660), and, may allow the user to turn off the pop-up blocker for a specific 2nd level domain. The user may select to disable or re-enable the pop-up blocker for any 2nd level domain.

Exemplary network-specific information (1240) are default Domain Name Servers (DNS) to be applied to every new or transferred domain name registered through the toolbar. The DNS settings may include entry fields which may populate the <hostname1>, <hostname2> and <techhandle> fields in the affiliate code embedded in toolbar hyperlinks. The toolbar may do field level validations on the DNS and Tech Handle fields to ensure that (1) all data entered is valid and (2) that all three fields are populated. If the validation routine fails the toolbar may display an error/warning message to the user in a dialogue box.

Exemplary validation routines are as follows:
Hostname 1 and Hostname 2 are formatted as name servers;
Hostname 1 and Hostname 2 are active, valid name servers (ping the name servers);
a Tech handle is a valid NIC Handle.

If user does not specify a Hostname 1, Hostname 2 and Tech Handle, then, the toolbar may update all affiliate coded links so as to not utilize these variables. All subsequent hyperlinks in the WHOIS Search Results and Wildcard Search Results pages may continue this rule, so that if a user does not specify these variables in the options area, the coded links may be modified to not include these variables.

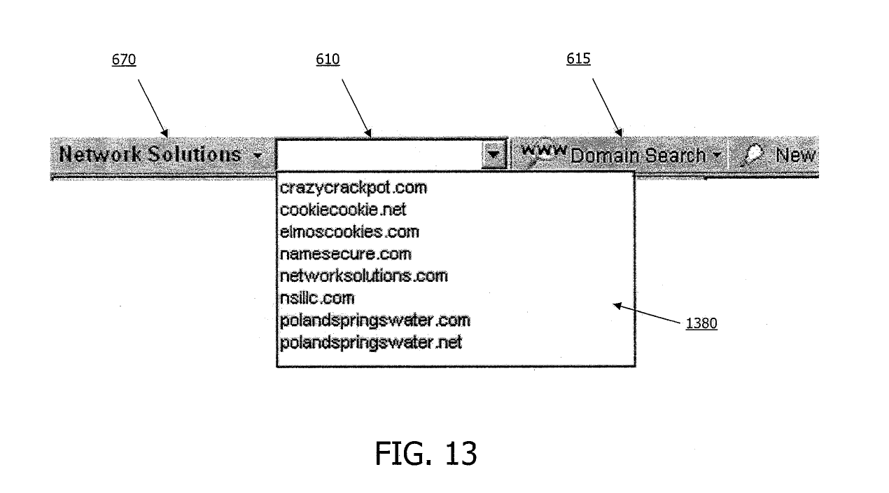

FIG. 13 illustrates a search history (1380) that may be included with the toolbar text entry box (610) as a pull-down/drop-down. The user may be provided an option to clear the history, and searches are saved in the drop down menu only if a user has selected the option to store their search history. If searches are saved, and if the number saved reaches a preset maximum, the oldest search may be replaced by a new search in the search history. The search history can remain indefinitely so long as the user does not clear his/her history, or turn off the store search history feature in the Options dialogue box.

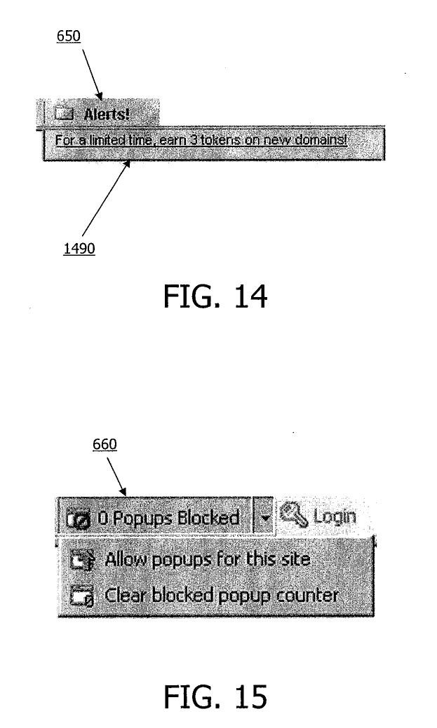

FIG. 14 is an example of the alert menu (650) displaying an alert (1490) received by the toolbar. The alerts may be done via Real Simple Syndication (RSS) functionality as pushed by the service provider in a private, protected online channel, or transmitted to the toolbar in response to a periodic request from the toolbar over the private, protected online channel. Alerts may be sent to the entire community of toolbars at one time. When an alert is pushed to the toolbar and has not been seen by the user, the Alerts button and icon may change appearance to notify the user that a new alert has been sent and not yet seen. Once all sent alerts are read, the toolbar will change the icon back to the original color/display.

The toolbar may be configured to display a maximum number of alerts (e.g., three) at any given time. Then, new alerts coming in will replace the oldest alert in the toolbar. Alerts may be set to only be live for a sender-specified period of time when the alert is created (e.g., in days). After than time, the alert will expire and be removed from the toolbar view, and may be recovered by the end user.

The alerts may be simple text messages, and may be hyperlinked to any URL specified by the sender. The alert hyperlinks can be implemented to pass no affiliate coded variables or DNS information.

FIG. 15 illustrates the pop-up blocker feature (660) reporting the number of windows blocked. The feature may also include a pull down/pop up menu enabling customization of the pop-up blocker feature. For example, by selecting “allow popups for this site”, the site currently viewed within the browser is added to a “whitelist” where popups having a whitelisted originating address are permitted to pop-up. This information is saved so that when the site is visited in the future, popups are allowed for that site. “Clear blocked popup counter” resets the field (660) appearing in the toolbar interface (230).

FIG. 16 illustrates a browser-and-system tools interface (680) as a pull-down/drop down menu that may integrated into the toolbar interface (230) (not shown in FIG. 6). Examples of functions that may be made available in interface (680) include: “Clear Cookies” to clear cookies recorded by the browser (210); “Clear Browser Cache” to clear the cache of the browser (210); “Clear Browser History” to clear the history of the browser (210); “Clear Auto-Complete” to clear auto-fill information for web forms recorded by the browser 210 and/or agent 250; “Clear Search History” to clears the Toolbar search history (1380); “Clear Recycle Bin” to clear items designated as to be deleted on the computer (1800) on which the browser (210) and toolbar plug-in (220) are executed; “Clear Clipboard” clears the clipboard of the operating system of the computer (1800); “Clear System Temp Directory” clears all files from the temp directory of a file system of the computer (1800); and “Clear Recent Documents” clears a list of recent documents from the menu of the operating system of the computer (1800) (e.g., the “Start” menu in Microsoft® Windows®).

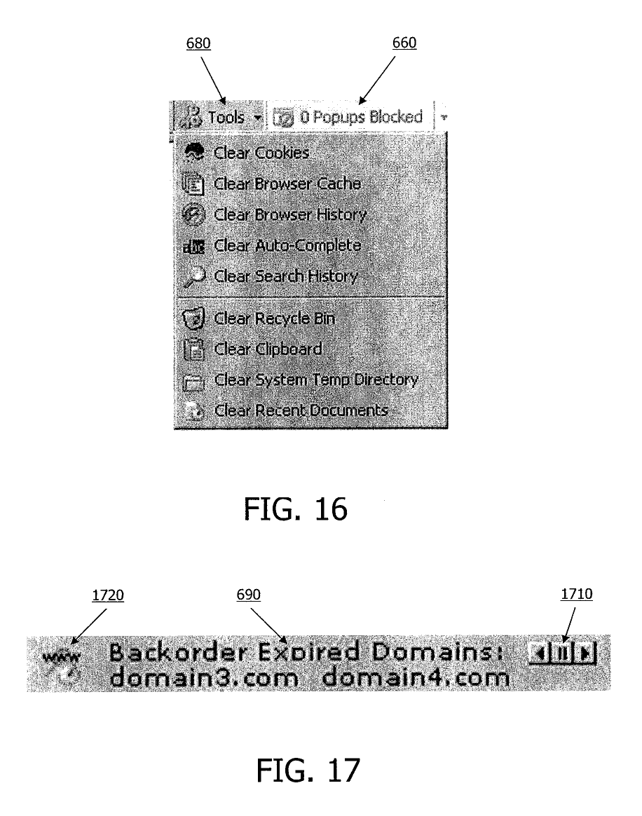

FIG. 17 illustrates a text stream “ticker” (690) that can be incorporated into the toolbar interface (230) (not shown in FIG. 6). For example, as shown in FIG. 17, an listing of recently expired domains scrolls across the toolbar ticker field (690). Controls (1710) are provided to allow a user to pause the ticker and change its direction (reverse and forward). If a user sees an expired domain of interest and clicks on the domain name, the selected domain name is passed to a service so that an order or backorder can be placed. As the list of recently expired domains appearing in the ticker is preferably an abbreviated subset of expired domains, functionality may also included via either the ticker, a button (1720), or one of the menus (e.g., 670, 770, 1030) to link to an alphabetical directory of all expired domains.

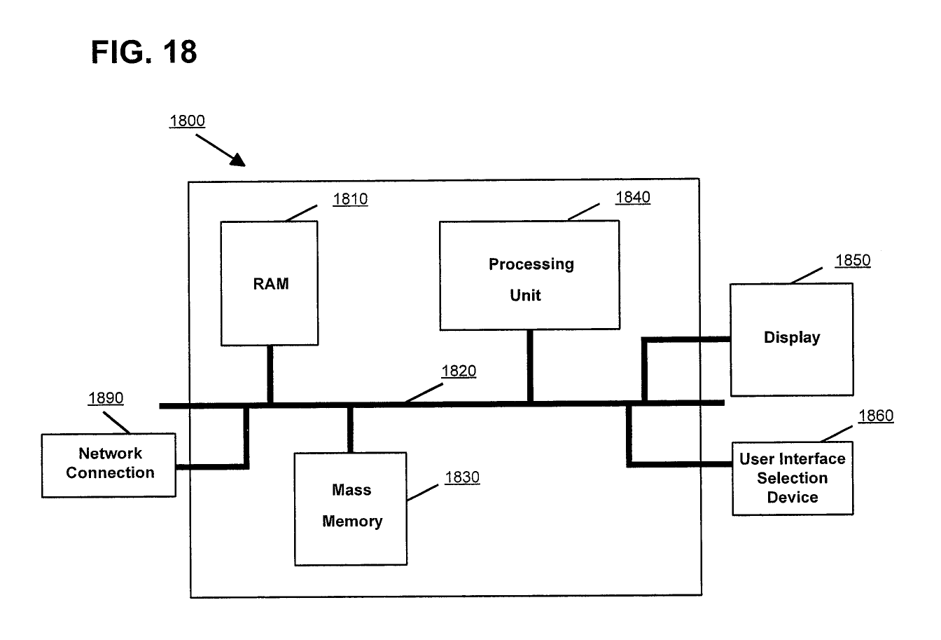

FIG. 18 is a block diagram of a computer upon which the toolbar is executed.

The computer (1800) includes a processing unit (1840), active memory (1810), archival memory or storage (1830), a display (1850), the user interface selection device (1860), and a network connection (1890). The elements are connected by a bus or busses (1820). The software instructions for executing the toolbar on the processing unit 1840 are stored on a machine readable storage medium, such as in the storage memory 1830. Upon execution by the processing unit 1840, the software instructions may be copied into active memory 1810, which may also contain data generated by the toolbar.

The toolbar components (toolbar, installation windows, upgrade windows, etc.) and associated flows/pages (e.g. WHOIS Search Results, WHOIS Entry, Wildcard Search, etc.) may be created with centralized branding resource files to allow the provider of the toolbar to quickly change the branding with ease.

Communications to/from the toolbar and associated flows/pages may be created with de-coupled standard APIs. This will allow a toolbar service provider to reuse the front-end results pages.

Embedded in the toolbar may be a specific (to each end-user) and/or unique identifier code so that a WHOIS service provider, domain name registrar, or intervening service provider can know each end-user's traffic and subsequent sales derived from the toolbar. Further, each button or hyperlink within the toolbar may invoke pre-defined (e.g., by the provider of the toolbar) specific codes so that the subsequent traffic and sales generated from the toolbar will be recognized.

Additionally, the specific code allows a service provider to independently limited the number of queries from any particular toolbar per day, and may separately, limit the number of queries per hour, or other time period.

An ancillary application allows the toolbar provider to “pre-load” the identifier code to each toolbar prior to distribution of the toolbar. The toolbar provider may provide the ancillary application with the following fields—(1) each users name, (2) a unique ID (“affiliateID”), and (3) each users (delivery) email address. The ancillary application applies each affiliateID to each instance of the toolbar and generates a pre-defined “Welcome” message to the end user that contains the customized-to-the-end user toolbar executable pre-loaded with the unique affiliateID for that end user. Toolbar and service providers may be provided the ability to query for a single affiliateID or email address as stored by the ancillary application.

The ability to push version updates to all toolbars in active service may be included. This helps in the event of a critical bug that needs to be fixed in active toolbars. This can be done by a routine run in each toolbar to check for a new update upon each new browser session when the toolbar is active in the browser.

The toolbar may notify the user that a new upgraded version is available, offer the user a hyperlink to find out more information, and ask the user if he wants to install now, or ask the user to uninstall the toolbar.

Other features that may be included in the toolbar comprise the ability for user to see WHOIS history changes; the ability for user to get alerts based upon the domains they have searched; a SPAM database lookup; a DNS lookup; a Reverse DNS lookup; Tracert (also known as TraceRoute); Ping; Abuse lookup; ISP cached DNS lookup; and IP routing lookup.

In addition to the features described above, the toolbar may include the following features:

1. An alert (1490) for customer-specified keyword watch list for expired domains.

2. An alert (1490) for a customer's expiring domains (listing of domains that need renewals).

3. An alert (1490) on other expiring services on a customer's account (hosting, email, etc.).

4. Links to make a Certified Offer on Registered Domains. Certified Offers for Registered Domains provides functionality to the toolbar user to submit offers to an entity that can effectuate the transfer of an existing a domain name, such as a domain name registrar, an entity with a contractual relationship with a domain name registrar, a registry, or an independent entity offering the domain name transfer. For example, if the toolbar user attempts to register a domain name, but the domain name has already been registered to another, the toolbar user may select a link (either from a results page, or directly from the toolbar) to make a certified offer to purchase the domain name registration from its present registrant. The links may also include an appraisal service link to assist the user in determining an appropriate amount to offer the registrant for the domain name.

5. Alerts (1490) on results of Certified Offers for Registered Domains.

6. A File Transfer Protocol (FTP) tool built into toolbar for the downloading of files, including features such anonymous and automatic authentication login, and including support for passive mode and active mode client protocols.

7. Access Hosting dashboard for personal Hosting accounts, from the toolbar.

8. Access to Web usage statistics from the toolbar. When a user selects Web usage statistics from the toolbar for a web site, statistics are presented which may include how many times a page has been viewed, how many unique visitors a page receives, how many visits were referrals from other sites and from whence the referrals came, uptime statistics, load time statistics, which keywords are being used by search engines to find the site, statistics regarding how much time a visitor spends on the page, statistics regarding how many viewers are return visitors and how often they return, what operating systems visitors to the site are using, statistics regarding what languages are designated as preferred by visitors' browsers, statistics regarding the country of origin of visitors, and the frequency with which visitors request a reload of a page.

9. An interface for viewing HTTP command traffic from the toolbar.

10. An interface to access to Search engine ranking from the toolbar. A search engine ranking is where a particular (company) Uniform Resource Locator (URL) listing appears in a search engine's list when a certain term (keyword) is entered into the search engine. Search engine rankings may also include rankings in web directories. For example, a user would select search engine ranking from the toolbar. The user would then be prompted to enter in a URL and one or more keywords. The results are delivered to the user either via a webpage or a pop-up, and include how that the URL with keyword(s) ranks among a plurality of search engines. The toolbar may also allow the user to indicate which search engines the user is interested in seeing ranked, presenting the user with a list of search engines and allowing the user to select and deselect.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A toolbar, operable on a computer system including a display having a graphical user interface, the toolbar comprising:
a first plurality of selectable items, comprising at least one item corresponding to a predefined interaction with a WHOIS database, and at least one item corresponding to a predefined interaction with a domain name registrar;
a text entry box; and
an agent to receive a first selection of an item of the first plurality of selectable items and a string from the text entry box, and to prepare and send a first query over a network, based upon the first selection and the string, and to output first results received in response to the first query to the display,
wherein the toolbar is a plug-in to a web browser program,
wherein the toolbar is to be selectively displayed, an option to be provided to display and hide the toolbar; and
wherein, if set to be displayed, at least a portion of the toolbar is to be persistently displayed in a graphical user interface, independent of changes in content displayed by the web browser program.

2. The toolbar according to claim 1, the first plurality of selectable items further comprising at least one of a Ping service, a TraceRoute service, an Internet Protocol Address lookup, and a Domain Name Service record lookup.

3. The toolbar according to claim 1, the first plurality of selectable items further comprising, and a service to make a certified offer on a registered domain.

4. The toolbar according to claim 1, wherein said agent is to output the first results received in response to the first query on the display through the web browser program.

5. The toolbar according to claim 1, wherein said first plurality of selectable items consists of at least one of a pull-down menu, a drop-down menu, or a plurality of buttons.

6. The toolbar according to claim 1, wherein the computer system further includes a user-interface selection device enabling a user to select content on the display, the toolbar further comprising:
a pop-up menu, to be activated by the user through the user interface selection device, the pop-up menu including a second plurality of selectable items comprising at least one item corresponding to a predefined interaction with the WHOIS database, and at least one item corresponding to a predefined interaction with a domain name registrar, the second plurality of selectable items further comprising at least one of a Ping service, a TraceRoute service, an Internet Protocol Address lookup, a Domain Name Service record lookup, and a service to make a certified offer on a registered domain; and
wherein the agent is to further receive selected content and a second selection of an item of the second plurality of selectable items, and is to prepare and send a second query over a network, based upon the selected content and the second selection, and to output second results received in response to the second query on the display.

7. The toolbar according to claim 6, wherein the selected content is text.

8. The toolbar according to claim 6, wherein the selected content is a graphic object including embedded information, said agent using at least some of the embedded information to prepare the second query.

9. The toolbar according to claim 1, further comprising an interface for viewing HyperText Transport Protocol command traffic.

10. The toolbar according to claim 1, further comprising an interface to retrieve search engine ranking data.

11. The toolbar according to claim 1, further comprising a field displaying a notification that one or more messages has been received by the toolbar via the network, if one or more messages is received over the network from the domain name registrar, selection of the notification field to cause the toolbar to display of said one or more messages.

12. A method for disseminating information related to ownership of a domain name over a computer network comprising:
providing a toolbar as a plug-in to a web browser program, the toolbar configured to receive a message over a private, protected online channel on the computer network and including an interface to display said message;
receiving a request from the toolbar over the computer network for notification of an event related to ownership of the domain name; and
responsive to an occurrence of said event, transmitting a message over the private, protected online channel to the toolbar,
wherein the event is selected from one of an expiration of a domain name specified in said request, an expiration of a domain name including a keyword specified in said request, and receipt of a result to a certified offer to purchase an already-owned domain name specified in said request.

13. The method according to claim 12, wherein the toolbar is configured to automatically and periodically request transmittal of any messages for display in said interface.

14. The method according to claim 12, wherein the toolbar is preconfigured to establish said private, protected online channel to a domain name registrar.
